(19) United States
(12) Patent Application Publication
(10) Pub. No.: US 2018/0236491 A1
(43) Pub. Date: Aug. 23, 2018

(54) SEPARATION APPARATUS WITH SCREEN HAVING VARIABLE APERTURES

(71) Applicant: Frito-Lay North America, Inc., Plano, TX (US)

(72) Inventor: Joseph H. GOLD, Dallas, TX (US)

(21) Appl. No.: 15/440,576

(22) Filed: Feb. 23, 2017

(51) Int. Cl. B07B 1/46

(52) U.S. Cl. CPC B07B 1/4636

(57) ABSTRACT

A novel separation screen, a separation apparatus utilizing the separation screen, and a method for product separation are disclosed herein. The separation screen is formed from a first screening element having a first plurality of openings passing through the first screening element and a second screening element movably coupled to the first screening element. The second screening element is oriented parallel to the first screening element and has a second plurality of openings passing through the second screening element. The separation screen also includes an adjustment device integrated with at least one of the first screening element or the second screening element to control the effective size of the plurality of apertures in the separation screen.

### BACKGROUND OF THE INVENTION

### Technical Field

The present invention disclosure relates generally to a method and apparatus for separating a feed stream based on particle size. More particularly, the disclosure herein describes an improved separation apparatus with a novel separation screen formed from at least two parallel screening elements movably coupled together so that an effective size of the plurality of apertures of the separation screen can be changed.

### Background

A vibratory screener, also colloquially referred to as a sifter, is a separation apparatus that can separate a feed stream into two or more product streams, each having particles of different sizes. There are two predominant types of vibratory screeners, centrifugal screeners and longitudinal screeners. Currently existing centrifugal screeners use one or more circular separation screens to separate a feed stream into two or more product streams. The feed stream is generally deposited in the central area of the circular separation screen and centrifugal motion causes the particles to move towards a perimeter of the screen for extraction. Larger particles unable to pass through the holes in the screen are removed from the centrifugal screener as a retained product stream. Smaller particles of the feed stream fall through the holes in the separation screen during agitation and can be collected as a pass-through product stream. To achieve more than two product streams, multiple screening steps are performed with two or more separation screens in series.

A longitudinal screener uses a rectangular separation screen to separate a feed stream into two or more product streams. The particles of a feed stream are deposited onto the upstream end of a separation screen, which is then vibrated to cause the particles of the feed stream to travel down a length of the separation screen. Larger particles unable to pass through the holes in the separation screen are removed at a downstream end of the separation screen as a retained product stream. Smaller particles of the feed stream fall through the holes in the screen during agitation and are collected as a pass-through product stream. To achieve more than two product streams, multiple screening steps are performed with two or more separation screens in series.

To change the size distribution of particles in the product streams, an installed separation screen would need to be replaced with another screen having uniform holes of a different size to achieve the desired separation. However, this process is time consuming because it requires a technician to take the vibratory screener apart and make the necessary changes. In the meantime, the production line needs to be shut down temporarily, which reduces throughput and profit.

### SUMMARY OF THE INVENTION

In a first embodiment, the present disclosure provides for a novel separation screen for separating a feed stream into two product streams based on particle size. The separation screen, which has a plurality of apertures with an effective size, includes a first screening element with a first plurality of openings passing through the first screening element. The separation screen also includes a second screening element with a second plurality of openings passing through the second screening element. The second screening element is movably coupled to the first screening element, and oriented parallel to the first screening element. The separation screen also includes an adjustment device integrated with at least one of the first screening element or the second screening element to control the effective size of the plurality of openings.

In a second embodiment, the disclosure provides for an improved separation apparatus configured with a novel separation screen for separating a feed stream into two product streams based on particle size. The separation apparatus includes a housing defining a separation chamber, and a separation screen mounted within the separation chamber. The separation screen has a plurality of apertures and includes a first screening element with a first plurality of openings passing through the first screening element. The separation screen also includes a second screening element with a second plurality of openings passing through the second screening element. The second screening element is movably coupled to the first screening element, and oriented parallel to the first screening element. The separation screen also includes an adjustment device integrated with at least one of the first screening element or the second screening element to control the effective size of the plurality of openings.

In a third embodiment, the disclosure provides for a method of separating a feed stream into two product streams using an improved separation apparatus configured with a novel separation screen for separating a feed stream into two or more product streams based on particle size. A feed stream is introduced into a separation apparatus that includes a housing that stores a separation screen having a plurality of apertures with an effective size. The separation screen is formed from a first screening element and a second screening element movably coupled to the first screening element, each screening element comprising a plurality of holes that form opposing ends of the plurality of apertures. At least one of the first screening element or the second screening element is adjusted to change the effective size of the plurality of apertures of the separation screen. Thereafter, the feed stream is separated into a retained product stream and a pass-through product stream using the separation screen.

Other aspects, embodiments and features of the invention will become apparent from the following detailed description of the invention when considered in conjunction with the accompanying drawings. The accompanying figures are schematic and are not intended to be drawn to scale. In the figures, each identical, or substantially similar component that is illustrated in various figures is represented by a single numeral or notation. For purposes of clarity, not every component is labeled in every figure, nor is every component of each embodiment of the invention shown where illustration is not necessary to allow those of ordinary skill in the art to understand the invention.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is an exemplary separation screen in accordance with a first embodiment.

FIGS. 2a and 2b are section views of the separation screen from FIG. 1 illustrating how the effective size of the plurality of apertures can be changed in accordance with an illustrative embodiment.

FIGS. 3a and 3b are plan views of a portion of the separation screen from FIG. 1 depicting how the effective size of the plurality of apertures can be changed in accordance with an illustrative embodiment.

FIG. 4 is an exemplary separation screen in accordance with a second embodiment.

FIG. 5 is a plan view of the separation screen from FIG. 4 depicting how the effective size of the plurality of apertures can be changed in accordance with an illustrative embodiment.

FIG. 6 is an exemplary longitudinal sifter configured for housing the separation screen of FIG. 1 in accordance with an illustrative embodiment.

FIG. 7 is an exemplary centrifugal sifter configured for housing the separation screen of FIG. 4 in accordance with an illustrative embodiment.

FIG. 8 is a method for product separation in accordance with an illustrative embodiment.

### DETAILED DESCRIPTION

Aspects of the present disclosure relate generally to novel separation screens designed with at least two screening elements that are movably coupled together, which facilitates the changing of the effective size of some or all of the plurality of apertures in the separation screens. Modifications to the separation screen in the manner described herein allows an operator to change the size distribution of the particles in the product streams without the need to shut down the process to manually change or add separation screens. This reduces cost by reducing the number of screens that must be maintained, and by reducing the number of technicians that must be employed to change out separation screens. Profits may be increased by minimizing the amount of production downtime ordinarily allocated to screen changes. Other benefits will be become apparent as the novel aspects are disclosed in further detail.

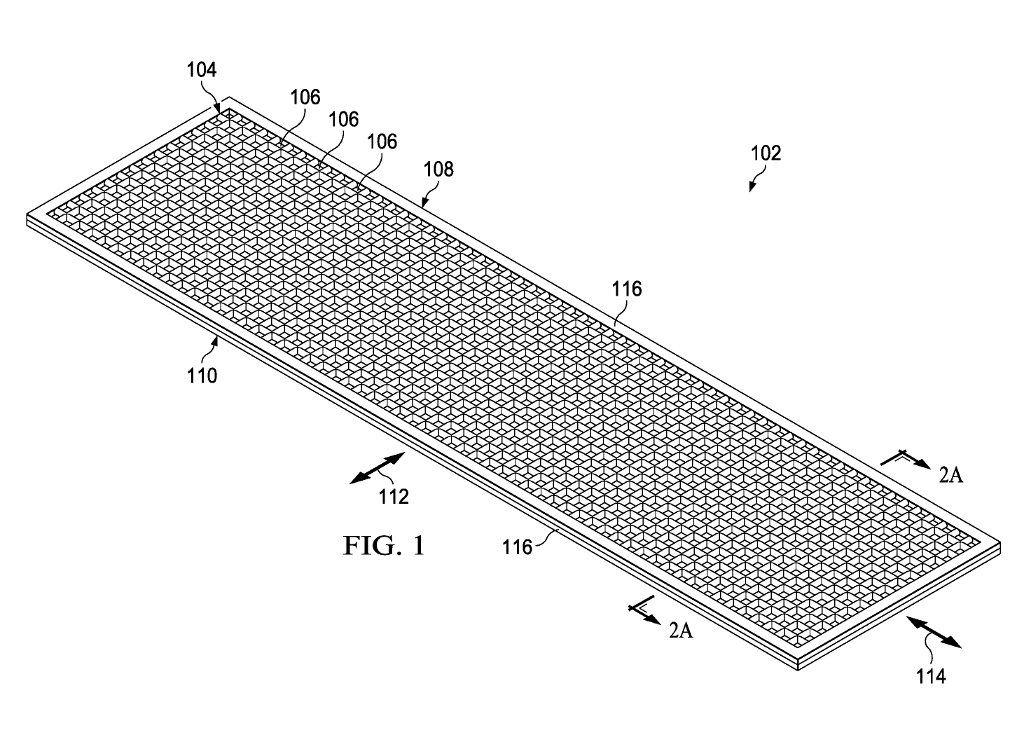

FIG. 1 is a separation screen in accordance with an illustrative embodiment. Separation screen 102 has an operative surface 104 on which a first end of a plurality of apertures 106 is disposed. The separation screen 102 can be installed into a longitudinal sifter to separate a feed stream into a plurality of product streams based upon the size of the particles that form the feed stream. Particles too large to pass through the separation screen 102 are conveyed down the length of the operative surface 104 and removed at a downstream end of the separation screen 102 as a retained product stream. Particles small enough to pass through the separation screen 102 are removed from the longitudinal sifter as a pass-through product stream.

Separation screen 102 is formed from at least two screening elements 108 and 110 each of which define separate planes that are oriented parallel to one another. In this illustrative embodiment, the first screening element 108 forms the upper half of separation screen 102 and is located above the second screening element 110, which forms the lower half of the separation screen 102. Consequently, the first screening element 108 may be described as the upper screening element and the second screening element 110 may be described as the lower screening element.

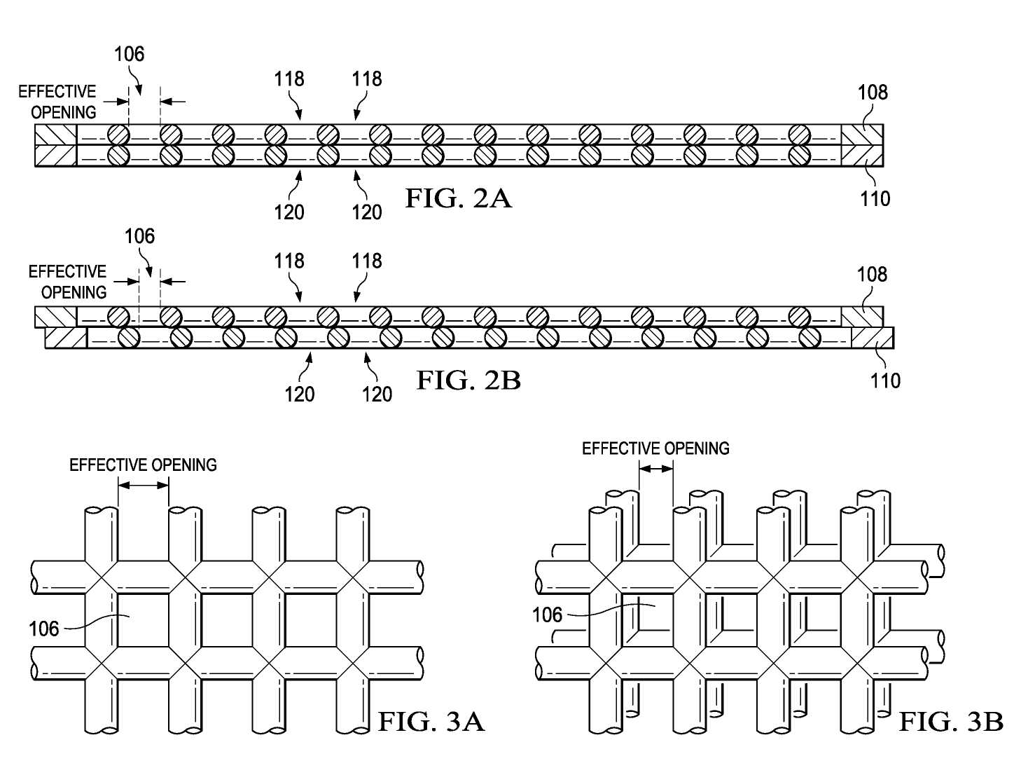

Each of the first screening element 108 and the second screening element 110 has a plurality of holes that pass entirely through from one side to the other side, as can be seen in more detail in FIG. 2. Additionally, in one embodiment, each hole in the plurality of holes of the first screening element 108 corresponds to another hole in the plurality of holes in the second screening element 110 to form a pair of holes that defines one aperture in the plurality of apertures 106 of separation screen 102. More specifically, a hole in the first screening element 108 forms a first end of an aperture of separation screen 102 and a corresponding hole in the second screening element 110 forms the other end of the aperture of separation screen 102. Moving one of the separation screens relative to the other changes the effective size of the plurality of apertures 106, as will be discussed in more detail with respect to FIG. 2 below.

In one embodiment, the first screening element 108 and the second screening element 110 have identical form factors so that when their edges are aligned, each hole in the first screening element 108 is directly aligned with a corresponding hole in the second screening element 110, as shown in FIG. 2A. However, in alternate embodiments, the first screening element 108 and the second screening element 110 have different form factors but have at least some holes that are aligned with holes in the other screening element. In yet another embodiment, the first screening element 108 and the second screening element 110 may have the same form factor, but different numbers of holes so that only some of the holes in one of the screening elements have a corresponding hole in the other screening element.

The first screening element 108 and the second screening element 110 are movably coupled to one another so that either one or both of the screening elements may be moved relative to the other. For example, in one embodiment, the first screening element 108 and the second screening element 110 may be housed in a frame (not shown) that securely fastens one of the screening elements to prevent it from moving, but includes an integrated adjustment device that permits the other screening element to move to a different position in the same plane in the direction of arrows 112 and 114. Alternatively, the frame may partially secure each of the screening elements 108 and 110 to permit limited movement in their respective planes, along the direction of arrows 112 and 114. The movement of one or both of the screening elements 108 and 110 controls of the effective size of each of the plurality of apertures 106 in separation screen 102, as will be discussed in more detail below. Once the relative position of screening elements 108 and 110 has been adjusted so that the plurality of apertures 106 have the desired effective size, the screening elements 108 and 110 may be secured so that subsequent vibratory motion will be unable to change their relative positions, and thus the effective size of apertures 106. The screening elements 108 and 110 may be secured together using any conventional means, such as locking devices or mounts.

In this illustrative embodiment in FIG. 1, the upper surface of the first screening element 108 forms the operative surface 104 of the separation screen 102. The operative surface 104 of the separation screen 102 is generally flat and may be formed in a manner that is conventional in the art. For example, the operative surface may be formed from woven strands of wire or polymeric line and reinforced around the perimeter by a rigid frame 116. In an alternate embodiment, the operative surface may be formed from a single sheet of material, such as plastic or metal, with openings disposed throughout. The openings may be formed by boring through the sheet of material or thermoformed with the openings already integrated therein. In such an embodiment where the operative surface is sufficiently rigid, the rigid frame 116 may be excluded.

FIG. 2A and 2B depict section views of the separation screen from FIG. 1 illustrating how the effective opening size of the plurality of apertures can be changed in accordance with an illustrative embodiment. Specifically, the effective opening size of each of the plurality of apertures 106 in separation screen 102 can be changed by controlling the relative position of the first screening element 108 to the second screening element 110, which changes the alignment of the plurality of holes 118 and the plurality of holes 120.

With particular reference to FIG. 2A, separation screen 102 is shown with the first screening element 108 aligned with and movably coupled to the second screening element 110. As can be seen, the first screening element 108 has a plurality of holes 118 that passes entirely through the first screening element from one side to the other. Similarly, the second screening element 110 has a plurality of holes 120 that passes entirely through the second screening element 110 from one side to the other. Thus, each hole in the first screening element 118 forms a first end of an aperture in the plurality of apertures 106 in separation screen 102, and each hole in the second screening element 120 forms a second end of an aperture in the plurality of apertures 106. Each aperture in the plurality of apertures 106 has an effective opening that can be controlled based upon the amount of overlap between the plurality of holes 118 and 120. In the embodiment where the first screening element 108 and the second screening element 110 have identical form factors and the edges are aligned, each of the plurality of apertures 106 in separation screen 102 has a continuous, uniform cross-sectional area as can be seen in FIG. 2A. In this particular configuration, the effective size of the plurality of apertures 108 is at a maximum. By changing the relative position of the first screening element 108 to the second screening element 110—by moving either the first screening element 108, moving the second screening element 110, or both—the effective size of the plurality of apertures 106 can be changed, as shown in FIG. 2B.

In FIG. 2B, the effective opening size of the plurality of apertures 106 in separation screen 102 has been reduced relative to the effective opening size of the plurality of apertures 106 shown in FIG. 2A by changing a relative position of the screening elements. In this particular embodiment, the second screening element 110 was shifted in the direction of arrow 112 to reduce the effective size of the plurality of apertures 106 in a single dimension. In another embodiment, the second screening element 110 may be shifted in the direction of arrow 114 to reduce the effective size of the plurality of apertures 106. In yet another embodiment, the second screening element 110 can be moved in the direction of both arrows 112 and 114 to reduce the effective size of the plurality of apertures 106 in two dimensions, as shown in FIGS. 3A and 3B. Alternatively, both screening elements 108 and 110 may be adjusted relative to the other. For example, screening element 108 may be shifted in the direction of arrow 112 and screening element 110 may be shifted in the direction of arrow 114. These descriptions are for purposes of illustration and are not to be construed as excluding other directions of movement or means of adjustment.

FIGS. 3a and 3b are plan views of a portion of the separation screen from FIG. 1 depicting how the effective size of the plurality of openings can be changed in accordance with an illustrative embodiment. In FIG. 3A, each hole in the first screening element 108 is aligned with another hole in the second screening element 110, thus the second screening element 110 is beneath the first screening element 108 and obscured. However, in FIG. 3B, the relative position of the first screening element 108 and the second screening element 110 is changed along two axes, for example in the direction of arrows 112 and 114 in FIG. 1 to reduce the effective size of the plurality of apertures 106 in two dimensions.

Although each of the screening elements 108 and 110 depicted in FIGS. 2A, 2B and FIGS. 3A, 3B have the same number of equally-sized openings, in an alternate embodiment, one of the screening elements may have openings of a different size. For example, the second screening element 110 may have openings that are twice as large so that shifting the second screening element 110 relative to the first screening element 108 would only reduce the effective opening of every other aperture. In yet another embodiment, the separation screen 102 may have three or more screening elements stacked in series to obtain more granular control over the size of the particles in the feed stream.

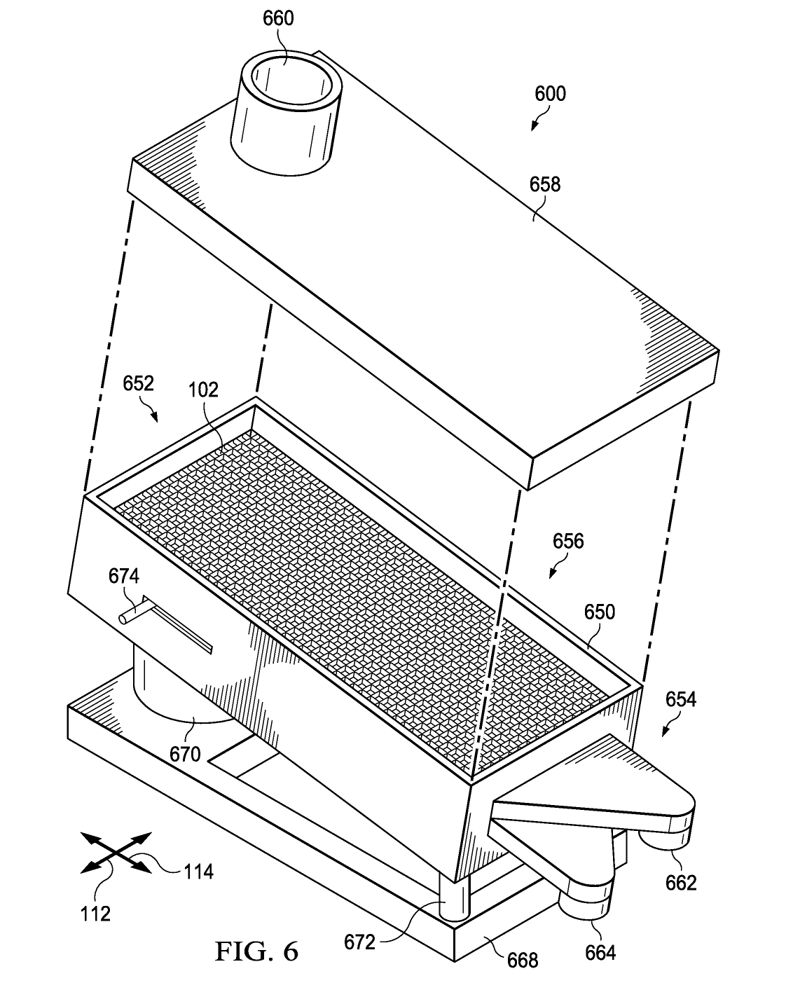

The separation screen 102 can be used with a longitudinal sifter. A longitudinal sifter is a separation device that separates a feed stream into two or more product streams by conveying at least some particles of the feed stream down a length of the operative surface 104 of the separation screen 102 for removal as a retained product stream. A non-limiting example of a longitudinal sifter configured with a separation screen 102 is depicted in FIG. 6 below.

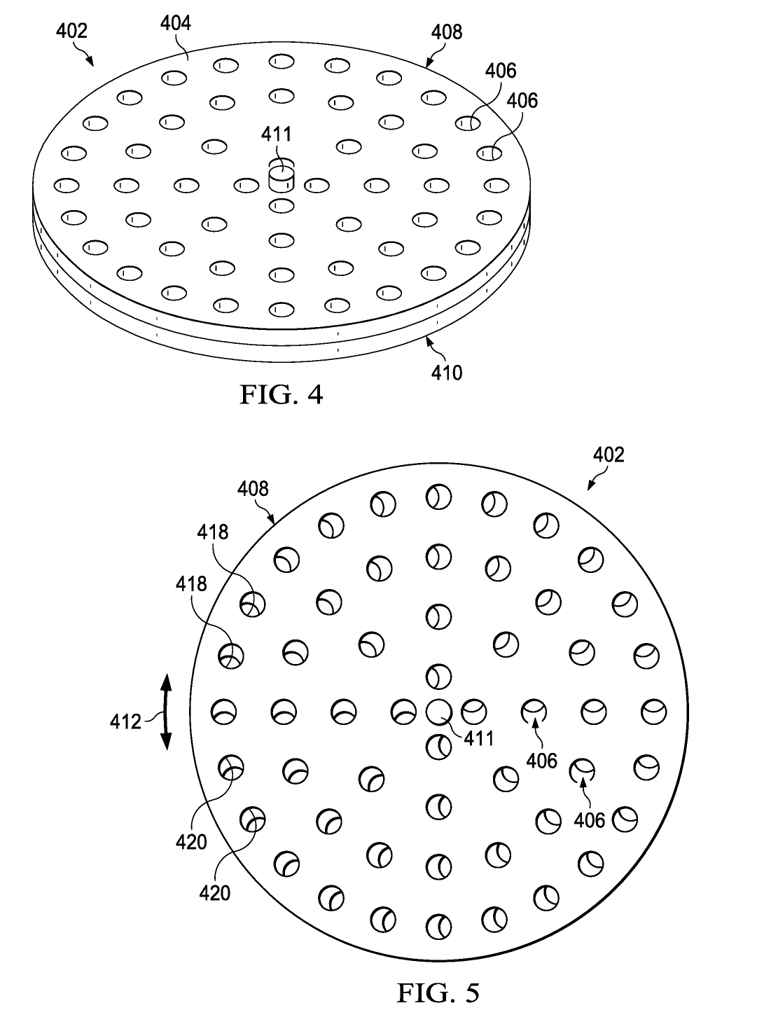

FIG. 4 is a separation screen for use in a centrifugal sifter in accordance with an illustrative embodiment. Separation screen 402 has an operative surface 404 on which a first end of a plurality of apertures 406 is disposed. The separation screen 402 can be installed into a centrifugal sifter to separate a feed stream into a plurality of product streams based upon the size of the particles that form the feed stream. Particles too large to pass through the separation screen 402 are conveyed from a generally central location to the outer perimeter of the operative surface 404 and removed as a retained product stream. Particles small enough to pass through the separation screen 402 removed from the centrifugal sifter as a pass-through product stream.

Separation screen 402 is formed from at least two screening elements 408 and 410 each of which define separate planes that are oriented parallel to one another. In this illustrative embodiment, the first screening element 408 forms the upper half of separation screen 402 and is located above the second screening element 410, which forms the lower half of the separation screen 402. Consequently, the first screening element 408 may be described as the upper screening element and the second screening element 410 may be described as the lower screening element.

Each of the first screening element 408 and the second screening element 410 has a plurality holes that pass entirely through from one side to the other side. Additionally, in one embodiment, each hole in the plurality of holes of the first screening element 408 corresponds to another hole in the plurality of holes in the second screening element 410 to form a pair of holes that defines one aperture in the plurality of apertures 406 of separation screen 402. More specifically, a hole in the first screening element 408 forms a first end of an aperture of separation screen 402 and a corresponding hole in the second screening element 410 forms the other end of the aperture of separation screen 402. Moving one of the separation screens relative to the other changes the effective size of the plurality of apertures 406, as will be discussed in more detail with respect to FIG. 5 below.

The first screening element 408 and the second screening element 410 are movably coupled to one another so that either one or both of the screening elements may be moved relative to the other. For example, in this non-limiting embodiment of FIG. 4, the first screening element 408 is attached to the second screening element 410 by a fastener 411 located in the center of each of the screening elements 408 and 410. The fastener defines a common axis of rotation. In another embodiment, the first screening element 408 and the second screening element 410 may be housed in a frame (not shown) that securely fastens one of the screening elements to prevent it from moving, but includes an adjustment device that permits the other screening element to move to a different position or orientation in the same plane in the direction of arrow 412 in FIG. 5. Alternatively, the frame may partially secure each of the screening elements 408 and 410 to permit limited movement in their respective planes, along the direction of arrow 412. The movement of one or both of the screening elements 108 and 110 controls of the effective size of each of the plurality of apertures 406 in separation screen 402, as will be discussed in more detail with respect to FIG. 5. Once the relative position of screening elements 408 and 410 has been adjusted so that the plurality of apertures 406 have the desired effective size, the screening elements 408 and 410 may be secured so that subsequent vibratory motion will be unable to change their relative positions, and thus the effective size of apertures 406. The screening elements 408 and 410 may be secured together using any conventional means, such as locking devices or mounts.

In this illustrative embodiment in FIG. 4, the upper surface of the first screening element 408 is the operative surface 404 of the separation screen 402. The operative surface 404 of the separation screen 402 is generally flat and may be formed in a manner that is conventional in the art. For example, the operative surface may be formed from woven strands of wire or polymeric line and reinforced around the perimeter by a rigid frame. In an alternate embodiment, the operative surface may be formed from a single sheet of material, such as plastic or metal, with openings disposed throughout. The openings may be formed by boring through the sheet of material or thermoformed with the openings already integrated therein.

FIG. 5 is a plan view of the separation screen from FIG. 4 depicting how the effective size of the plurality of apertures 406 can be changed in accordance with an illustrative embodiment. Generally, rotation of either the first screening element 408 or the second screening element 410 causes the effective size of the plurality of apertures 406 to change. In the example of FIG. 5, the second screening element 410 is rotated along the common axis defined by fastener 411 in the direction of arrow 412 to reduce the effective size of the plurality of apertures 406. Specifically, each of the plurality of openings 418 of the first screening element 408 are partially aligned with the each of the plurality of openings 420 of the second screening element 410 so that the plurality of apertures 406 has a reduced effective size.

FIG. 6 is a perspective view of an exemplary longitudinal sifter configured for separating the particles of a feed stream using the separation screen of FIG. 1 in accordance with an illustrative embodiment. Separation apparatus 600 includes a housing 650 that has an upstream end 652 and a downstream end 654. The housing 650 defines a separation chamber 656 configured to securely mount the separation screen 102 therein. The separation chamber 656 may be enclosed by a removable lid 658. Extending outwardly from the removable lid 658, proximate to the upstream end 652, is an inlet 660. At the downstream end 654 of the housing 650 is a set of outlets for extracting separated feed streams from the separation apparatus 600. In this embodiment, separation apparatus 600 includes outlets 662 and 664.

The housing 650 is movably mounted to a frame 668, which serves as an immobile base for the separation apparatus 600. In the non-limiting example shown in FIG. 6, the housing 650 is angled relative to the frame 668 so that gravity can assist the movement of feed particles down a length of the operative surface 104 of the separation screen 102. Movement is imparted to the housing 650 by a vibration device 670. In this non-limiting embodiment, the vibration device 670 is secured to the base 668 and attached to the upstream end 652 of the housing. The downstream end 654 of the housing 650 is supported by, but moveably engaged with the frame 668 so that the vibration device 670 can cause the housing 650 to move while frame 668 is maintained stationary. The downstream end 654 of the housing 650 may be supported by movable linkages 672, such as a ball joints or slipper plates. In operation, the vibration device 670 induces movement in the housing 650 which is transferred to the separation screen 102, which in turn causes the particles of a feed stream on the separation screen 102 to travel from an upstream location of the separation screen 102 to a downstream end on the operative surface 104.

In this illustrative embodiment, the separation chamber 656 is an elongate volume of space in which product separation is conducted. The separation chamber 656 is bounded on the upper end by a removable lid 658, which encloses the separation chamber 656 to minimize the generation of dust and prevent contamination of the product streams by foreign objects. Mounted within the separation chamber 656 is the separation screen 102, which effectively divides the separation chamber 656 into an upper section and a lower section.

A feed stream introduced into the separation chamber 656 via the inlet 660 is aggregated on the separation screen 102 and separated into two feed streams based on size. The sizes of the particles in the retained product stream and the pass-through product stream can be controlled by changing the effective size of the plurality of apertures 106 of the separation screen 102. In this illustrative embodiment in FIG. 6, the separation screen 102 is configured with an adjustment device 674 in the form of a handle that protrudes outwardly from the housing 650 of separation apparatus 600 to allow a user to manually adjust the relative position of the first and second screening elements 108 and 110 without having to stop the separation process, expose the separation screen 102, and perform the necessary adjustments to one or both of the screening elements 108 or 110 from within the separation chamber. Once the separation screen 102 has been adjusted so that the plurality of apertures 106 have the desired effective size, the separation screen 102 is optionally secured within the separation chamber 656 to prevent the first and second screening elements 108 and 110 from shifting during operation and inadvertently changing the effective size of the plurality of apertures 106. The separation screen 102 may be secured according to any conventional means.

After the effective size of the plurality of apertures 106 has been selected, the feed stream is separated into two streams by conveying at least part of the feed stream down a length of the operative surface 104 of separation screen 102. Particles small enough to pass through the plurality of apertures 106 of the separation screen 102 are collected at a downstream end 654 of the separation apparatus 600 as a pass-through product stream, and particles too large to pass through the plurality of apertures 106 are conveyed down a length of the operative surface 104 of the separation screen 102 and collected at the downstream end 654 as a retained product stream. In this illustrative embodiment, the pass-through product stream is collected from outlet 662 and the retained product stream is collected from outlet 662.

Although the adjustment device 674 is depicted as a single handle coupled to one of the screening elements of separation screen 102, in an alternate embodiment, each of the screening elements 108 and 110 may be connected to its own handle so that each of the screening elements may be moved independently. Furthermore, the depiction of a handle as the adjustment device 674 should be deemed as a non-limiting embodiment. Thus in other embodiments, the adjustment device 674 may be a mechanical system utilizing other forms of controllers, such as dials or knobs, which can be manipulated to move one or both of the screening elements in an incremental manner. In yet another embodiment, the adjustment device 674 may take the form of an electromechanical system utilizing computer-controlled actuators for adjusting the relative position of the first screening element 108 to the second screening element 110. In this example of in FIG. 6, adjustment device 674 permits the movement of at least one of the screening elements 108 and 110 along arrows 112 and 114. The direction of movement can be described as lateral so that each of the screening elements 108 and 110 are maintained in their respective planes parallel to each other.

Stacking two or more separation screens 102 in series would permit the recovery of more than two separated product streams. For example, a first separation screen 102 can be secured above a second separation screen 102 within a separation chamber 656 of a modified separation apparatus 600. Importantly, the plurality of apertures 106 on the second separation screen 102 should be adjusted to have an effective size that is smaller than the plurality of apertures 106 on the first separation screen. The first retained product stream would be removed from the separation apparatus 600 as previously described. Particles of the pass-through product stream would fall through the first separation screen 102 and onto the second separation screen. As the housing 650 is agitated, the feed particles are conveyed down a length of the second separation screen 102 and further separated into a second retained product stream and a pass-through product stream. In this example, by stacking two separation screens 102 in series, three product streams may be recovered. Any number of separation screens may be placed in series to achieve a desired number of separated product streams having a particular particle sizes.

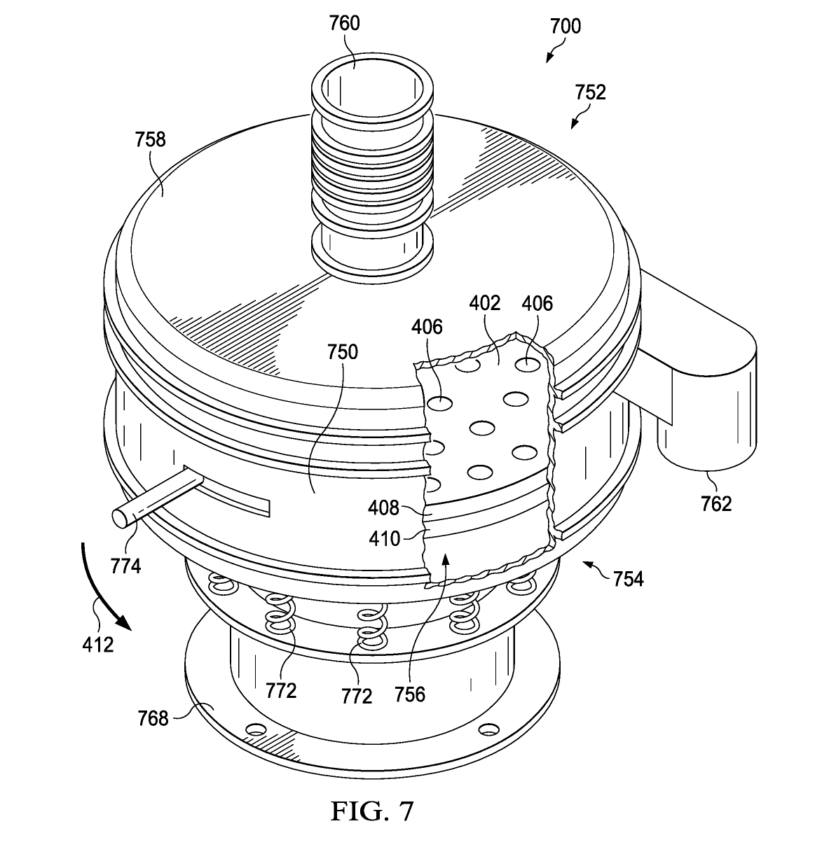

FIG. 7 is an exemplary centrifugal sifter configured for housing the separation screen of FIG. 4 in accordance with an illustrative embodiment. The separation apparatus 700 includes a housing 750 that has an upstream end 752 and a downstream end 754. The housing 750 defines a separation chamber 756 configured to securely mount a separation screen 402 therein. The separation chamber 756 may be enclosed by a removable lid 758. Extending outwardly from the removable lid 758 is an inlet 760. The housing 750 includes a set of outlets for extracting separated feed streams. In this illustrative embodiment, housing 750 includes two outlets. The first, outlet 762, is configured to extract a retained product stream, and the second outlet, which is obscured in this drawing, is located at the downstream end 754 of the housing 750 and configured to extract a pass-through product stream.

The housing 750 is movably mounted to a frame 768, which serves as an immobile base for the separation apparatus 700. Movement is imparted to the housing 750 by a vibration device (not shown). The vibration device may be secured to the base 768 and also attached to the downstream end 752 of the housing 750, or attached directly to the housing 750. The downstream end 754 of the housing 750 is supported by, but moveably engaged with the frame 768 so that the vibration device can cause the housing 750 to move while frame 768 is maintained stationary. The downstream end 754 of the housing 750 may be supported by movable linkages 772, such as springs. In operation, the vibration device induces movement in the housing 750 which is transferred to the separation screen 402, which in turn causes the particles of a feed stream on the separation screen 402 to travel from a generally central location on the operative surface 404 of the separation screen 402 towards the outer perimeter.

The housing 750 defines an internal separation chamber 756, which is a generally cylindrical volume of space. The separation chamber is bounded on the upper end by a removable lid 758, which encloses the separation chamber 762 to minimize the generation of dust and prevent contamination of the product streams by foreign objects. Mounted within the separation chamber 762 is the separation screen 402, which effectively divides the separation chamber 762 into an upper section and a lower section.

A feed stream introduced into the separation chamber 762 via the inlet 760 is aggregated on the separation screen 402 and separated into two feed streams based on size. The sizes of the particles in the retained product stream and the pass-through product stream can be controlled by changing the effective size of the plurality of apertures 406 of the separation screen 402. In this illustrative embodiment in FIG. 7, the separation screen 402 is configured with an adjustment device 774 in the form of a handle that protrudes outwardly from the housing 750 of separation apparatus 700 to allow a user to manually adjust the relative position of the first and second screening elements 408 and 410 without having to stop the separation process, expose the separation screen 402, and perform the necessary adjustments to one or both of the screening elements 408 or 410 from within the separation chamber. Once the separation screen 402 has been adjusted so that the plurality of apertures 406 have the desired effective size, the separation screen 402 is secured within the separation chamber 762 to prevent the first and second screening elements 408 and 410 from shifting during operation and inadvertently changing the effective size of the plurality of apertures 406. The separation screen 402 may be secured according to any conventional means.

After the effective size of the plurality of apertures 406 has been selected, the feed stream is separated into two streams by agitating the particles of the feed stream as they are in contact with separation screen 402. Agitation is achieved by vibration device (not shown). The agitation imparts centrifugal force to the particles of feed stream on separation screen 402, which causes smaller particles to pass through the separation screen 402 and pushes the larger particles to the periphery of the separation screen 402 for subsequent removal. In this illustrative embodiment, the pass-through product stream is collected from an outlet located at the downstream end 754 of the housing 750 and the retained product stream is collected from outlet 762.

Although the adjustment device 754 is depicted as a single handle coupled to one of the screening elements of separation screen 402, in an alternate embodiment, each of the screening elements 406 and 408 may be connected to its own handle so that each of the screening elements may be moved independently. Furthermore, the depiction of a handle as the adjustment device 754 should be deemed as a non-limiting embodiment. Thus in other embodiments, the adjustment device 754 may be a mechanical system utilizing other forms of controllers, such as dials or knobs, which can be manipulated to move one or both of the screening elements in an incremental manner. In yet another embodiment, the adjustment device 754 may take the form of an electromechanical system utilizing computer-controlled actuators for adjusting the relative position of the first screening element 408 to the second screening element 410. In any event, the adjustment device 754 changes the relative orientation of the first screening element 408 and the second screening element 410 by causing at least one of the screening elements to rotate along a shared axis.

As already discussed, two or more separation screens 402 may be stacked in series to separate a feed stream into more than two product streams. In this illustrative embodiment in FIG. 7, the curved sidewall of the housing 750 corresponds to a single removable, cylindrical segment that houses one separation screen 402. Stacking another cylindrical segment above or below the existing cylindrical segment increases the height of the separation apparatus 700 but allows the separation apparatus 700 to accommodate two or more separation screens. A feed stream introduced into the inlet 760 is separated into two product streams. The first product stream is removed from the outlet 762 and the pass-through product stream is separated again by a second separation screen 402. Accordingly, two retained product streams and one pass through product stream may be recovered.

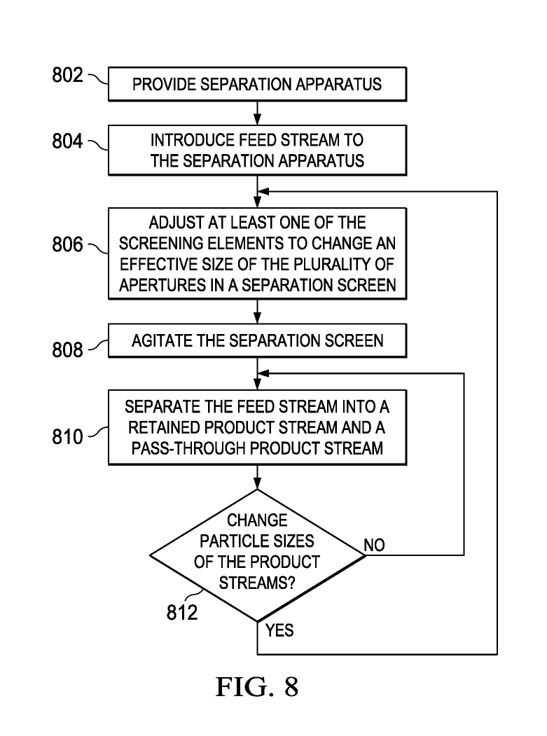

FIG. 8 is a method for product separation in accordance with an illustrative embodiment. The method begins by providing a separation apparatus comprising a housing that includes a separation screen with a plurality of apertures with an effective size that can be varied (Step 800). The separation screen may be formed from a first screening element comprising a first plurality of openings passing through the first screening element and a second screening element movably coupled to the first screening element. The second screening element is oriented parallel to the first screening element, and includes a second plurality of openings passing through the second screening element. The separation screen also includes an adjustment device integrated with at least one of the first screening element or the second screening element to control the effective size of the plurality of apertures.

A feed stream is introduced to the separation apparatus (Step 804). At least one of the screening elements is adjusted to change the effective size of the plurality of apertures (Step 806). In the embodiment wherein the separating apparatus is a centrifugal sifter, the adjusting step further comprises rotating one of the screening elements relative to the other along a shared axis to change the effective size of each of the plurality of apertures. In the embodiment wherein the separation apparatus is a longitudinal sifter, the adjusting step further comprises repositioning one of the screening elements in any lateral direction within its plane. The screening elements may be optionally secured to prevent the effective sizes of each of the plurality of apertures from inadvertently changing.

The separation screen is agitated (Step 808). Agitation causes the feed stream to be separated into a retained product stream and a pass-through product stream (Step 810). In some embodiments, an optional step is performed that entails making a determination as to whether the particle sizes of the product streams should be changed (Step 812). If the particles sizes of the product streams should be changed, then the process returns to Step 806 so that the effective size of the plurality of apertures can be changed. If the particles sizes of the product streams should not be changed, then in one embodiment, the method may return to Step 810 to continue separation. Alternatively, the method may terminate.

Although embodiments of the invention have been described with reference to several elements, any element described in the embodiments described herein are exemplary and can be omitted, substituted, added, combined, or rearranged as applicable to form new embodiments. A skilled person, upon reading the present specification, would recognize that such additional embodiments are effectively disclosed herein. For example, where this disclosure describes characteristics, structure, size, shape, arrangement, or composition for an element or process for making or using an element or combination of elements, the characteristics, structure, size, shape, arrangement, or composition can also be incorporated into any other element or combination of elements, or process for making or using an element or combination of elements described herein to provide additional embodiments. For example, it should be understood that the method steps described herein are exemplary, and upon reading the present disclosure, a skilled person would understand that one or more method steps described herein can be combined, omitted, re-ordered, or substituted.

Additionally, where an embodiment is described herein as comprising some element or group of elements, additional embodiments can consist essentially of or consist of the element or group of elements. Also, although the open-ended term “comprises” is generally used herein, additional embodiments can be formed by substituting the terms “consisting essentially of” or “consisting of.”

While this invention has been particularly shown and described with reference to preferred embodiments, it will be understood by those skilled in the art that various changes in form and detail may be made therein without departing from the spirit and scope of the invention. The inventors expect skilled artisans to employ such variations as appropriate, and the inventors intend the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### ADDITIONAL DESCRIPTION

In a first aspect, the disclosure describes a separation screen having a plurality of apertures with an effective size, the separation screen comprising a first screening element comprising a first plurality of openings passing through the first screening element; a second screening element movably coupled to the first screening element, wherein the second screening element is oriented parallel to the first screening element, and wherein the second screening element comprises a second plurality of openings passing through the second screening element; and an adjustment device integrated with at least one of the first screening element or the second screening element, wherein the adjustment device controls the effective size of the plurality of apertures.

Another embodiment including any one or more of the elements in a previous embodiment disclosed above, wherein the adjustment device is a handle attached to an edge of either the first screening element or the second screening element.

Another embodiment including any one or more of the elements in a previous embodiment disclosed above, wherein the adjustment device controls the effective size of the plurality of apertures by changing an alignment of the first plurality of openings and the second plurality of openings.

Another embodiment including any one or more of the elements in a previous embodiment disclosed above, wherein the adjustment device controls the effective size of the plurality of apertures by changing a position of at least one of the first screening element or the second screening element.

Another embodiment including any one or more of the elements in a previous embodiment disclosed above, wherein the separation screen is circular, and wherein the adjustment device changes the position of the at least one of the first screening element or the second screening element by changing a rotational orientation relative to the other screening element.

Another embodiment including any one or more of the elements in a previous embodiment disclosed above, wherein the separation screen is rectangular, and wherein the first screening element defines a first plane and the second screening element defines a second plane parallel to the first plane, and wherein the adjustment device causes at least one of the first screening element or the second screening element to change its position relative to the other screening element.

Another embodiment including any one or more of the elements in a previous embodiment disclosed above, wherein the effective size of each of the plurality of apertures is at a maximum when the first plurality of openings in the first screening element are perfectly aligned with the second plurality of openings in the second screening element.

In a second aspect, the disclosure describes a separation apparatus comprising a housing defining a separation chamber; a separation screen having a plurality of apertures, the separation screen maintained within the separation chamber, wherein the separation screen comprises: a first screening element comprising a first plurality of openings passing through the first screening element; a second screening element movably coupled to the first screening element, wherein the second screening element is oriented parallel to the first screening element, and wherein the second screening element comprises a second plurality of openings passing through the second screening element; and an adjustment device integrated with at least one of the first screening element or the second screening element, wherein the adjustment device controls the effective size of the plurality of apertures.

Another embodiment including any one or more of the elements in a previous embodiment disclosed above, wherein the adjustment device is a handle attached to an edge of either the first screening element or the second screening element.

Another embodiment including any one or more of the elements in a previous embodiment disclosed above, wherein the adjustment device controls the effective size of the plurality of apertures by changing an alignment of the first plurality of openings and the second plurality of openings.

Another embodiment including any one or more of the elements in a previous embodiment disclosed above, wherein the adjustment device controls the effective size of the plurality of apertures by changing a position of at least one of the first screening element or the second screening element.

Another embodiment including any one or more of the elements in a previous embodiment disclosed above, wherein the separation screen is circular, and wherein the adjustment device changes the position of the at least one of the first screening element or the second screening element by changing a rotational orientation relative to the other screening element.

Another embodiment including any one or more of the elements in a previous embodiment disclosed above, wherein the separation screen is rectangular, and wherein the first screening element defines a first plane and the second screening element defines a second plane parallel to the first plane, and wherein the adjustment device causes at least one of the first screening element or the second screening element to change its position relative to the other screening element.

Another embodiment including any one or more of the elements in a previous embodiment disclosed above, wherein the effective size of each of the plurality of apertures is at a maximum when the first plurality of openings in the first screening element are perfectly aligned with the second plurality of openings in the second screening element.

In a third aspect, the disclosure describes a method for separating a feed stream into a plurality of product streams, the method comprising: introducing a feed stream into a separation apparatus, wherein the separation apparatus comprises a housing that stores a separation screen having a plurality of apertures with an effective size, wherein the separation screen is formed from a first screening element and a second screening element movably coupled to the first screening element, wherein the first screening element and the second screening element each comprise a plurality of holes that form opposing ends of the plurality of apertures; adjusting at least one of the first screening element or the second screening element to change the effective size of the plurality of apertures of the separation screen; and separating the feed stream into a retained product stream and a pass-through product stream using the separation screen.

Another embodiment including any one or more of the elements in a previous embodiment disclosed above, wherein the method further comprises agitating particles of the feed stream on the separation screen.

Another embodiment including any one or more of the elements in a previous embodiment disclosed above, wherein the separation apparatus is a centrifugal sifter and wherein the adjusting step further comprises: rotating at least one of the first screening element or the second screening element relative to the other along a shared axis to change the effective size of each of the plurality of apertures.

Another embodiment including any one or more of the elements in a previous embodiment disclosed above, wherein the separating apparatus is a longitudinal sifter, and wherein the adjusting step further comprises: repositioning at least one of the first screening element and the second screening element in any direction along the same plane.

Another embodiment including any one or more of the elements in a previous embodiment disclosed above, wherein the method further comprises: mounting a second separation screen in series with the first separation screen; and separating the pass-through product stream into a second retained product stream and a second pass-through product stream.

1. A separation screen having a plurality of apertures with an effective size, the separation screen comprising:
a first screening element comprising a first plurality of openings passing through the first screening element;
a second screening element movably coupled to the first screening element, wherein the second screening element is oriented parallel to the first screening element, and wherein the second screening element comprises a second plurality of openings passing through the second screening element; and
an adjustment device integrated with at least one of the first screening element or the second screening element, wherein the adjustment device controls the effective size of the plurality of apertures by changing a rotational orientation of the first screening element relative to the second screening element.

2. The separation screen of claim 1, wherein the adjustment device is a handle attached to an edge of either the first screening element or the second screening element.

3. The separation screen of claim 1, wherein the adjustment device controls the effective size of the plurality of apertures by changing an alignment of the first plurality of openings and the second plurality of openings.

4. The separation screen of claim 1, wherein the adjustment device controls the effective size of the plurality of apertures by changing a position of at least one of the first screening element or the second screening element.

5. The separation screen of claim 1, wherein the separation screen is circular.

6. (canceled)

7. The separation screen of claim 1, wherein the effective size of each of the plurality of apertures is at a maximum when the first plurality of openings in the first screening element are perfectly aligned with the second plurality of openings in the second screening element.

8. A separation apparatus comprising:
a housing defining a separation chamber;
a separation screen having a plurality of apertures, the separation screen maintained within the separation chamber, wherein the separation screen comprises:
a first screening element comprising a first plurality of openings passing through the first screening element;
a second screening element movably coupled to the first screening element, wherein the second screening element is oriented parallel to the first screening element, and wherein the second screening element comprises a second plurality of openings passing through the second screening element; and
an adjustment device integrated with at least one of the first screening element or the second screening element, wherein the adjustment device controls the effective size of the plurality of apertures by changing a rotational orientation of the first screening element relative to the second screening element.

9. The separation screen of claim 8, wherein the adjustment device is a handle attached to an edge of either the first screening element or the second screening element.

10. The separation screen of claim 8, wherein the adjustment device controls the effective size of the plurality of apertures by changing an alignment of the first plurality of openings and the second plurality of openings.

11. The separation screen of claim 8, wherein the adjustment device controls the effective size of the plurality of apertures by changing a position of at least one of the first screening element or the second screening element.

12. The separation screen of claim 8, wherein the separation screen is circular.

13. (canceled)

14. The separation screen of claim 8, wherein the effective size of each of the plurality of apertures is at a maximum when the first plurality of openings in the first screening element are perfectly aligned with the second plurality of openings in the second screening element.

15. A method for separating a feed stream into a plurality of product streams, the method comprising:
introducing a feed stream into a separation apparatus, wherein the separation apparatus comprises a housing that stores a separation screen having a plurality of apertures with an effective size, wherein the separation screen is formed from a first screening element and a second screening element movably coupled to the first screening element, wherein the first screening element and the second screening element each comprise a plurality of holes that form opposing ends of the plurality of apertures;
adjusting at least one of the first screening element or the second screening element to change the effective size of the plurality of apertures of the separation screen, wherein the adjusting step further comprises rotating at least one of the first screening element or the second screening element relative to the other along a shared axis to change the effective size of each of the plurality of apertures;
separating the feed stream into a retained product stream and a pass-through product stream using the separation screen.

16. The method of claim 15, further comprising:
agitating particles of the feed stream on the separation screen.

17. (canceled)

18. (canceled)

19. The method of claim 15, further comprising:
mounting a second separation screen in series with the first separation screen; and
separating the pass-through product stream into a second retained product stream and a second pass-through product stream.

20. The method of claim 15, wherein the adjusting step can be performed without stopping the separation process.

21. The method of claim 15, wherein the adjusting step can be performed without exposing the separations screen.
